(19) United States
(12) Patent Application Publication
(10) Pub. No.: US 2004/0121236 A1
(43) Pub. Date: Jun. 24, 2004

(54) Lithium ion secondary batteries

(76) Inventors: Xi Shen, Shanghai (CN); Chuanfu Wang, Shenzhen (CN); Junging Dong, Shenzhen (CN)

Correspondence Address: EMIL CHANG, LAW OFFICES OF EMIL CHANG, 874 JASMINE DRIVE, SUNNYDALE, CA, 94086, US

(21) Appl. No.: 10/733,018

(22) Filed: Dec. 10, 2003

(30) Foreign Application Priority Data
Dec. 10, 2002 (CN) 021562415

(51) Int. Cl. H01M 4/62

(52) U.S. Cl. 429/232

(57) ABSTRACT

The present invention relates to a type of battery, in particular lithium ion secondary battery, where such battery include a positive electrode, a negative electrode, electrolyte, and a separator, where the positive and negative electrodes are smear with a mixture made from active ingredient, conductive paste and an additive paste, said mixture smear on the metal conductor. The positive terminal material preferably made from aluminum foil, and the negative terminal material preferably made from copper foil. The positive electrode conductive paste preferably made from aluminum powder or aluminum fiber, and the conductive paste for the negative electrode preferably made from copper powder or copper fiber. The resulting lithium ion secondary battery has lower internal resistance and better cycling characteristics, suitable for high rate discharge.

### PRIORITY CLAIM

This application claims priority to a Chinese patent application entitled “Lithium Ion Secondary Batteries” filed on Dec. 10, 2002, having an Application No. 021562415.

### FIELD OF INVENTION

The present invention relates to batteries, and, in particular, lithium ion secondary batteries.

### BACKGROUND

In recent years, with the extensive application of a variety of portable electronic products, rechargeable batteries, and in particular lithium-ion rechargeable batteries, due to its superior characteristics such as high voltage, high capacity, low voltage loss, and zero-memory-effect, has been widely used in a variety of applications. However, when compared to other types of secondary batteries, lithium ion battery has higher internal resistance. During the high rate discharge, the voltage immediately drops, discharge time greatly decreases, and battery capacity decreases. Generally speaking, non-aqueous electrolyte having low conductivity and regular electrode's low conductivity capability are the primary reasons for causing higher internal resistance in lithium ion batteries.

The positive electrode of the lithium ion secondary battery uses the layered oxide compound of lithium and transition metal as active ingredient, where the resulting powder has higher resistance and poor conductivity. Therefore, in order to improve the conductivity of the electrode, it is necessary to improve the electron flow between the active ingredient powder particles and between the active ingredient powder particles and the electrode terminals. Generally, carbon black, graphite, and carbon powder types can be made into conductive paste and added to the electrodes, and the contacts among the graphite powder particles results in conductivity. However, the conductivity rate of the graphite powder particles is approximately one-one thousandth of metals, thereby causing higher internal resistance. With respect to the graphite material for the negative electrode of the lithium ion secondary battery, although it has better conductivity over the positive electrode, for high rate discharge applications, its conductivity still needs to be improved.

To resolve the above described problems, Chinese published patent application, No. CN1265232 disclosed a type of lithium ion battery and the manufacturing method thereof using electrodes made from micrometer-level conductive fiber. Because electron pathways are formed by fiber, the conductivity of the electrodes is increased. The micrometer conductive fiber includes metal fiber and graphite fiber and comprises 0.1-50 wt % of the active ingredient of the electrode. Metal fiber includes iron, nickel, copper, zinc, titanium, aluminum, silver, gold and alloys such as stainless steel, etc. The preferable diameter of the fiber is 0.1-25 μm and the length ratio being 4-2500. However, when the lithium ion secondary battery is fully charged, the normal voltage is 4.25v, higher than the precipitate voltage of the metal fibers. If the metal is not properly chosen, it will cause harmful metal being introduced into the electrolyte, severely affecting the charging and cycling characteristics of the lithium ion secondary battery. Furthermore, too much metal fiber will lower the adhesion between the active ingredient and the adhesion paste as well as the density between electrode conductor and the active ingredient, thereby increasing the difficulty in smearing onto the electrode and decreasing the overall capability of the lithium ion secondary battery.

The present invention resolves common problems with batteries, in particular with lithium ion secondary batteries, problems such as high internal resistance and low capacity for high rate discharge. By adding novel conductive paste in the positive and negative electrodes, conductivity can be improved and lower internal resistance and better cycling characteristics can be obtained, suitable for high rate discharge applications of batteries, in particular lithium ion secondary batteries.

### SUMMARY

It is an object of the present invention to provide a battery having low internal resistance.

It is another object of the present invention to provide a battery having high cycling performance characteristics.

It is still another object of the present invention to provide a battery suitable for high rate discharge without affecting energy capacity.

Briefly, a type of battery is disclosed, comprising of a positive electrode, a negative electrode, electrolyte (or electrolyte solution), and a separator, where the positive and negative electrodes are smear with a mixture comprised of active ingredient, conductive paste and additive paste, on to said metal terminals of the electrodes. The conductive paste for the respective electrodes preferably made from corresponding metal of the electrodes, and the weight ratio of the conductive paste to the active ingredient is within certain weight range.

An advantage of the present invention is to provide a battery having low internal resistance.

Another advantage of the present invention is to provide a battery having high cycling performance characteristics.

Still another advantage of the present invention is to provide a battery suitable for high rate discharge without affecting energy capacity.

### DETAILED DESCRIPTION OF THE PREFERRED EMBODIMENTS

A type of battery is disclosed, comprising of a positive electrode, a negative electrode, electrolyte (or electrolyte solution), and a separator, where the positive and negative electrodes are smear with a mixture comprised of active ingredient, conductive paste and additive paste, on to said metal terminals of the electrodes. The conductive paste for the respective electrodes preferably made from corresponding metal of the electrodes, and the weight ratio of the conductive paste to the active ingredient is approximately 1.0-10.0 wt %.

The described conductive paste can be in the form of metal powder, where the average diameter of the metal powder particles is 0.1-5 μm. It can also be a mixture of metal powder and fiber, where the metal fiber diameter is 0.1-5 μm with the length ratio 2-100. In this conductive paste mixture of the metal powder and fiber, the metal powder comprises 80.0-98.0 wt % of the conductive paste and the metal fiber comprises 2.0-20.0 wt % of the conductive paste.

The positive terminal material preferably made from aluminum foil, and the negative terminal material preferably made from copper foil. The positive electrode conductive paste preferably made from copper powder or copper fiber, and the conductive paste for the negative electrode preferably made from copper powder or copper fiber.

With respect to the preferred embodiment of the present invention, the aluminum foil positive electrode conductive paste preferably made from aluminum powder or aluminum powder and aluminum fiber mixture, copper foil negative electrode conductive paste made from copper powder or copper powder and copper fiber mixture, corresponding to the material of the positive and negative terminals, ensuring proper voltage for the lithium ion secondary battery (approximately 4.2V). In this manner, other metal types will not be mixed in with the electrolyte and the charging and discharging characteristics as well as the cycling characteristics of the lithium ion secondary battery will not be affected. Conductive paste made from metal material has higher conductivity than conductive paste made from carbon material, thereby reducing the internal resistance of the electrodes. To have the same electrical resistance, less metal fiber having certain length ratio is needed than metal powder. Although it is easier to use metal fiber having certain length ratio to form a network structure for an electrode, thereby increasing the network of mutual contact points and forming superior conductive pathways. On the other hand, too much metal fiber will decrease the adhesion between the active ingredient and adhesive paste and the density between the active ingredient and the terminals. Thus, the present invention uses a mixture of metal powder and fiber as the conductive paste to lower the internal resistance while ensuring the strength of the adhesion to the electrodes. The above described positive and negative electrodes conductive paste comprises 1.0-10.0 wt % of the total weight of the positive and negative, preferably 2.0-7.0 wt %. If it is lower than 1.0wt %, internal resistance cannot be effectively reduced; if it is higher than 10.0 wt %, the capacity and the energy density of the lithium ion secondary battery will be affected. With respect to conductive paste made from a mixture of powder and fiber, metal powder comprises 80.0-98.0 wt %, with average diameter of powder particles at 0. 1-5 μm, metal fiber comprises 2-20 wt % of the conductive paste with fiber diameter around 0.1-5 μm and length ratio around 2-100, preferably 10-70 because it is most conducive to lowering the resistance rate. The above described conductive paste is specially formulated. Other common conductive paste from carbon material such as acetylene black, carbon black, carbon fiber and graphite, and other conductive metal material are referred as additive paste under the embodiments of the present invention.

Under the embodiments of the present invention, in the positive electrode of the described lithium ion secondary battery, there is a layered combined oxide. It is an active ingredient having certain structure, and it can have reverse reaction with the lithium ion. This type of active ingredient material is described by the following chemical formulas selecting from one of the following or a mixture thereof: LiₓNi_{1-y}Co_{y}O₂ (where 0.9=<x=<1.1, 0=<y=<1.0), LiₓMn_{2-y}B_{y}O₂ (where B is transition metal or non-metal, 0.9=<x=<1.1, 0=<y=<1.0).

In the embodiments of the present invention, in order for the lithium ion of the active ingredient of the negative electrode of the described lithium ion secondary battery being capable of being inserted and detached from the carbon material, in the actual embodiments, one of the following or a mixture thereof is selected: natural graphite, man-made graphite, MCMB, MCF, etc.

For the embodiments of said invention, the preferred components the electrolyte in the composition of the electrolyte solution of said lithium ion rechargeable battery include one or more of the following lithium salt or its mixture: lithium perchlorate, lithium aluminum chlorate, hexa fluro lithium phosphate, tetra fluro lithium borate, lithium halogenate, fluro hydro fluro oxy lithium phosphate, and, lithium sulfonate. Said solvent component uses a mixture of linear acidic ester and cyclic acidic ester. The linear acidic ester includes one the mixture of one or more of the following mixture: carbonic dimethyl ester, carbonic diethyl ester, carbonic methyl ethyl ester, carbonic ethyl propyl ester, carbonic dibenzl ester, ethyl methyl ester, ethyl ethyl ester, propyl methyl ester, propyl ethyl ester, dimethyl oxyl ethanol, diethyl oxyl ethanol, and other type of linear form of organic ester containing fluoride, sulfur or unsaturated bonds. The cyclic acidic ester includes a mixture of one or more of the following: carbonic ethyl ester, carbonic propyl ester, bicarbonic ethyl ester, γ-butyl propyl ester, sulfurous ester and other type of cyclic form of organic ester containing fluoride, sulfur or unsaturated bonds.

Paste for the positive and negative electrodes is made by dissolving appropriate adhesion paste in special solution and then adding normal conductive paste and mixing in the active ingredient; then, adding metal powder or a mixture of powder and fiber comprising 1.0-10.0 wt % of the total weight of the resulting paste, and well mixing the conductive paste. In the process of making the paste, the above-described metal powder and metal fiber can be used without special processing. This shows that the present invention is not limited to any particular type of metal powder or metal fiber manufacturing processes.

Other than the above-described preferred embodiments of the present invention with applications to batteries in general and in particular to lithium ion secondary batteries, there are no other special requirements.

### Embodiments

The following embodiments further describe the embodiments of the present invention. These embodiments explain the present invention but it is not to be construed as to limit the present invention.

### Embodiment 1

A certain amount of PVDF is mixed in a certain ratio into a NMP solution, LiCoO₂ and acetylene black are added to the solution, and the solution is mixed and becomes paste. The composition ratio is LiCoO₂: acetylene black: PVDF=92:4:4. Then, a mixture is added in an amount of 5.0 wt % of the total weight of the paste, the mixture being of aluminum powder (average powder particle diameter being 2.0 μm) and aluminum fiber (fiber diameter being 1.0 μm, length ratio being 20-50). In this mixture of aluminum powder and aluminum fiber, aluminum fiber comprises 10.0 wt %. The resulting paste is smeared evenly onto an aluminum foil having a thickness of 20 μm and dried under 120° C. After pressing, the positive electrode has a thickness of 120 μm.

A certain amount of PVDF is mixed in a certain ratio into a NMP solution, man-made graphite is then added to the solution, and the solution is mixed and becomes paste. The composition is man-made graphite: PVDF=95:5. Then, a mixture is added in an amount of 5.0 wt % of the total weight of the paste, the mixture being of copper powder (average powder particle diameter being 2.0 μm) and copper fiber (fiber diameter being 1.0 μm, length ratio being 20-50). In this mixture of copper powder and copper fiber, copper fiber comprises 10.0 wt %. The resulting paste is smeared evenly onto a copper foil having a thickness of 20 μm and dried under 120° C. After pressing, the negative electrode has a thickness of 120 μm.

The above described positive and negative electrodes are wrapped with a 25 μm thick propyl micro-porous separator into a cylindrical shape lithium ion secondary battery core, which is placed into a battery shell and welded. Then, LiPF₆, in 1 mol/dm³ concentration is mixed and dissolved in EC/DMC=1:1 and used as electrolyte and injected into the battery shell and sealed, forming a cylindrical lithium ion secondary battery having a diameter of 18 mm and height of 65 mm.

### Embodiment 2

In an embodiment similar to Embodiment 1, the mixture added to the positive electrode is in an amount of 2.0 wt % of the total weight of the paste, the mixture being of aluminum powder and aluminum fiber. In this mixture of aluminum powder and aluminum fiber, aluminum fiber comprises 10.0 wt %. The mixture added to the negative electrode is in an amount of 2.0 wt % of the total weight of the paste, the mixture being of copper powder and copper fiber. In this mixture of copper powder and copper fiber, copper fiber comprises 10.0 wt %.

### Embodiment 3

In an embodiment similar to Embodiment 1, the mixture added to the positive electrode is in an amount of 10.0 wt % of the total weight of the paste, the mixture being of aluminum powder and aluminum fiber. In this mixture of aluminum powder and aluminum fiber, aluminum fiber comprises 10.0 wt %. The mixture added to the negative electrode is in an amount of 10.0 wt % of the total weight of the paste, the mixture being of copper powder and copper fiber. In this mixture of copper powder and copper fiber, copper fiber comprises 10.0 wt %.

### Embodiment 4

In an embodiment similar to Embodiment 1, the mixture added to the positive electrode is in an amount of 5.0 wt % of the total weight of the paste, the mixture being of aluminum powder and aluminum fiber. In this mixture of aluminum powder and aluminum fiber, aluminum fiber comprises 5.0 wt %. The mixture added to the negative electrode is in an amount of 5.0 wt % of the total weight of the paste, the mixture being of copper powder and copper fiber. In this mixture of copper powder and copper fiber, copper fiber comprises 5.0 wt %.

### Embodiment 5

In an embodiment similar to Embodiment 1, the mixture added to the positive electrode is in an amount of 5.0 wt % of the total weight of the paste, the mixture being of aluminum powder and aluminum fiber. In this mixture of aluminum powder and aluminum fiber, aluminum fiber comprises 20.0 wt %. The mixture added to the negative electrode is in an amount of 5.0 wt % of the total weight of the paste, the mixture being of copper powder and copper fiber. In this mixture of copper powder and copper fiber, copper fiber comprises 20.0 wt %.

### Embodiment 6

In an embodiment similar to Embodiment 1, the mixture added to the positive electrode is in an amount of 0.5 wt % of the total weight of the paste, the mixture being of aluminum powder and aluminum fiber. In this mixture of aluminum powder and aluminum fiber, aluminum fiber comprises 10.0 wt %. The mixture added to the negative electrode is in an amount of 0.5 wt % of the total weight of the paste, the mixture being of copper powder and copper fiber. In this mixture of copper powder and copper fiber, copper fiber comprises 10.0 wt %.

### Embodiment 7

In an embodiment similar to Embodiment 1, the mixture added to the positive electrode is in an amount of 20.0 wt % of the total weight of the paste, the mixture being of aluminum powder and aluminum fiber. In this mixture of aluminum powder and aluminum fiber, aluminum fiber comprises 10.0 wt %. The mixture added to the negative electrode is in an amount of 20.0 wt % of the total weight of the paste, the mixture being of copper powder and copper fiber. In this mixture of copper powder and copper fiber, copper fiber comprises 10.0 wt %.

### Embodiment 8

In an embodiment similar to Embodiment 1, the mixture added to the positive electrode is in an amount of 5.0 wt % of the total weight of the paste, the mixture being of aluminum powder and aluminum fiber. In this mixture of aluminum powder and aluminum fiber, aluminum fiber comprises 1.0 wt %. The mixture added to the negative electrode is in an amount of 5.0 wt % of the total weight of the paste, the mixture being of copper powder and copper fiber. In this mixture of copper powder and copper fiber, copper fiber comprises 1.0 wt %.

### Embodiment 9

In an embodiment similar to Embodiment 1, the mixture added to the positive electrode is in an amount of 5.0 wt % of the total weight of the paste, the mixture being of aluminum powder and aluminum fiber. In this mixture of aluminum powder and aluminum fiber, aluminum fiber comprises 50.0 wt %. The mixture added to the negative electrode is in an amount of 5.0 wt % of the total weight of the paste, the mixture being of copper powder and copper fiber. In this mixture of copper powder and copper fiber, copper fiber comprises 50.0 wt %.

### Comparison 1

Using methods similar to Embodiment 1, without the positive and negative electrode conductive paste.

### Comparison 2

In an embodiment similar to Embodiment 1, the mixture added to the positive electrode is in an amount of 5.0 wt % of the total weight of the paste, the mixture being of aluminum powder and aluminum fiber. In this mixture of aluminum powder and aluminum fiber, aluminum fiber comprises 10.0 wt %.

### Comparison 3

In an embodiment similar to Embodiment 1, the mixture added to the negative electrode is in an amount of 5.0 wt % of the total weight of the paste, the mixture being of copper powder and copper fiber. In this mixture of copper powder and copper fiber, copper fiber comprises 10.0 wt %.

Testing of Battery Characteristics

1. Discharge characteristics.

Charging a cylindrical lithium ion battery made from the above methods to 4.2V using a constant voltage of 1000 mA; when the voltage reaches 4.2V, cut off current at 50 mA; and discharge at constant voltage at 800 mA with cutoff voltage at 2.75V. Measure the initial capacity and battery internal resistance.

2. Cycling characteristics.

Charging a cylindrical lithium ion battery made from the above methods and to charge and discharge using the above method 300 cycles. Measure capacity maintenance rate after 300 cycles.

3. Load characteristics.

Charging a cylindrical lithium ion battery made from the above methods to 4.2V using a constant voltage of 1000 mA; when the voltage reaches 4.2V, cut off when current reaches 50 mA. Measure under load the capacity maintenance rate and discharge voltage values.

4. From the above methods, the following results are obtained:

TABLE 1

| | | | | | | | | 5000 mA/ | Discharge |
|---|---|---|---|---|---|---|---|---|---|
| | Conductive | | | | Initial | Battery | Capacity | 800 mA | Voltage |
| | Additive by Total | | Fiber in | | Discharge | Internal | Maintenance | Discharge | at 5000 |
| | Weight | | Additive Paste | | Capacity | Resistance | Rate After | Maintenance | mA |
| | Positive | Negative | Positive | Negative | (mAh) | (mQ) | 300 Cycles % | Rate % | (v) |
| Embodiment 6 | 0.5 | 0.5 | 10.0 | 10.0 | 1709 | 55 | 88.0 | 67.8 | 3.34 |
| Embodiment 2 | 2.0 | 2.0 | 10.0 | 10.0 | 1685 | 46 | 90.5 | 88.9 | 3.45 |
| Embodiment 8 | 5.0 | 5.0 | 1.0 | 1.0 | 1618 | 47 | 93.7 | 86.1 | 3.46 |
| Embodiment 4 | 5.0 | 5.0 | 5.0 | 5.0 | 1619 | 43 | 93.3 | 94.3 | 3.48 |
| Embodiment 1 | 5.0 | 5.0 | 10.0 | 10.0 | 1624 | 41 | 93.2 | 94.5 | 3.49 |
| Embodiment 5 | 5.0 | 5.0 | 20.0 | 20.0 | 1626 | 40 | 92.8 | 95.2 | 3.48 |
| Embodiment 9 | 5.0 | 5.0 | 50.0 | 50.0 | 1614 | 39 | 87.1 | 96.1 | 3.47 |
| Embodiment 3 | 10.0 | 10.0 | 10.0 | 10.0 | 1543 | 37 | 93.6 | 95.6 | 3.49 |
| Embodiment 7 | 20.0 | 20.0 | 10.0 | 10.0 | 1364 | 35 | 93.1 | 96.5 | 3.47 |
| Comparison | — | — | — | — | 1718 | 58 | 86.4 | 63.7 | 3.32 |
| Comparison | 5.0 | — | 10.0 | — | 1620 | 47 | 91.3 | 84.3 | 3.36 |
| Comparison | — | 5.0 | — | 10.0 | 1722 | 48 | 90.8 | 82.6 | 3.42 |

5. Summary:

It is appropriate to have the positive and negative electrodes conductive paste be 1.0-10.0 wt % of the total weight of the positive and negative electrodes, preferably 2.0-10.0 wt %; and metal fiber be 5-20 wt % of the conductive paste, most suitable for lowering internal resistance.

While the present invention has been described with reference to certain preferred embodiments, it is to be understood that the present invention is not to be limited to such specific embodiments. Rather, it is the inventor's contention that the invention be understood and construed in its broadest meaning as reflected by the following claims. Thus, these claims are to be understood as incorporating and not only the preferred embodiment described herein but all those other and further alterations and modifications as would be apparent to those of ordinary skilled in the art.

We claim:

1. A lithium ion secondary battery, including positive electrode, negative electrode, electrolyte and separator, where the terminals of the positive and negative electrodes are smeared with an mixture comprising of an active ingredient, conductive paste, and other additive paste, the special characteristics being: the conductive paste is made from the metal material of the corresponding conductor, comprising 1.0-10.0 wt % of the total weight of the active ingredient.

2. A lithium ion secondary battery as recited in claim 1, the conductive paste is in metal powder form having average diameter of 0.1-5 μm.

3. A lithium ion secondary battery as recited in claim 1, the conductive paste is a mixture of metal powder and fiber, said fiber having a diameter of 0.1-5 μm, and the length ratio being 2-100; the metal powder is 80-98 wt % of the additive paste, and the metal fiber is 2.0-20.0 wt % of the additive paste.
